(19) United States
(12) Patent Application Publication
(10) Pub. No.: US 2013/0290977 A1
(43) Pub. Date: Oct. 31, 2013

(54) Computational Resource Allocation System And A Method For Allocating Computational Resources For Executing A Scene Graph Based Application At Run Time

(71) Applicant: SIEMENS AKTIENGESELLSCHAFT, Munchen (DE)

(72) Inventors: Jyotsna Khemka, Bangalore (IN); Ranajoy Malakar, Bangalore (IN)

(73) Assignee: Siemens Aktiengesellschaft, Munchen (DE)

(21) Appl. No.: 13/869,080

(22) Filed: Apr. 24, 2013

(30) Foreign Application Priority Data
Apr. 26, 2012 (IN) 467/KOL/2012

(51) Int. Cl. G06F 9/50

(52) U.S. Cl. CPC G06F 9/50
USPC 718/104

(57) ABSTRACT

A computational resource allocation system for allocating computational resources to various modules of a scene graph based application while the application is being executed may include a module mapper for receiving a set of modules to be used in the scene graph based application from a module repository and a set of computational resources available to process the modules from a computational resource repository, and mapping the set of modules onto the set of computational resources to generate a mapping, and an allocation manager configured to allocate the modules to the set of computational resources based on the mapping.

### CROSS-REFERENCE TO RELATED APPLICATIONS

This application claims priority to IN Patent Application No. 467/KOL/2012 filed Apr. 26, 2012. The contents of which is incorporated herein by reference in its entirety.

### TECHNICAL FIELD

The disclosure relates to allocation of computational resources for executing a scene graph based application. More specifically, the disclosure relates to allocation of computational resources for executing a scene graph based application at runtime.

### BACKGROUND

A scene graph is a graph based data structure commonly used for representing various elements and algorithms in a computation sequence. It consists of a collection of nodes arranged in a tree, or more generally, a graph. The evaluation of a scene graph by a scene graph engine typically renders the computational sequence. This is achieved by processing each node in the scene graph in a predetermined order according to their location in the computational sequence, when each node contributes a part of the context information necessary for rendering complete execution of the application.

Recently, scene graphs have been used as a basis for creating entire applications or critical components that can be embedded in other applications. For example platforms like XIP Builder allow the creation of sophisticated components that can display and manipulate medical images. Such functionality is created by wiring together reusable modules that are pre-compiled for a particular selected computational resource. Since scene-graphs are a declarative format, a system described by it can be implemented in computational resources. However, for every change in computational resource, a new scene graph would have to be created. Also, if a new computational resource is added then a new scene graph, with nodes that explicitly support the new computational resource, needs to be built before execution. Therefore, the following disadvantages are present in the above mentioned typical scenario:
The module/functionality is tied down to the computational resource and the user is not given a choice to test it on different computational resources at run time.
In case a new computational resource is added to the system and user wants to test the module/functionality on this new computational resource, the scene graph based application needs to be recompiled or modified explicitly for the new hardware which is not transparent to the end user.

### SUMMARY

One embodiment provides a computational resource allocation system for allocating computational resources to various modules of a scene graph based application while the application is being executed, the system comprising: a module mapper configured to receive a set of modules to be used in the scene graph based application from a module repository and a set of computational resources available to process the modules from a computational resource repository, and to map the set of modules onto the set of computational resources to generate a mapping, wherein an allocation manager allocates the modules to the set of computational resources based on the mapping.

In a further embodiment, the module mapper is configured to map the set of modules onto the set of computational resources based on a performance matrix history defined by performance of each module on various computational resources.

In a further embodiment, the system comprises a performance estimator configured to generate the performance matrix history of each of the module in the repository by executing each of the module individually on the computational resources in the computational resource repository, wherein the performance matrix history is generated before executing the scene graph based application.

In a further embodiment, the system comprises a computational resource manager configured to interact with the computational resource repository, to receive an availability update of the computational resources available for processing the modules from the set while executing the scene graph application and to update the set of computational resources available for processing the modules using the availability update.

In a further embodiment, the computational resource manager configured to receive a computational resource information from the computational resource repository whenever any computational resource is added to or deleted from the computational resource repository and update the set of computational resources based on the computational resource information.

In a further embodiment, the system comprises a memory manager configured to receive the mapping from the module mapper, to identify if any of the modules in the set to be executed consecutively uses same computational resource from the set and to determine data transfer between the computational resources in the set while executing modules of the scene based application consecutively except when the modules being executed consecutively uses the same computational resource.

Another embodiment provides a method for allocating computational resources to various modules of a scene graph based application while the application is being executed, the method comprising: receiving a set of modules to be used in the scene graph based application from a module repository and a set of computational resources available to process the modules from a computational resource repository by a module mapper, and mapping the set of modules onto the set of computational resources to generate a mapping, wherein an allocation manager allocates the modules to the set of computational resources based on the mapping.

In a further embodiment, mapping the set of modules onto the set of computational resources by the module mapper based on a performance matrix history defined by performance of each module on various computational resources.

In a further embodiment, the method comprises generating the performance matrix history of each of the module in the repository by a performance estimator by executing each of the module individually on the computational resources in the computational resource repository, wherein the performance matrix history is generated before executing the scene graph based application.

In a further embodiment, the method comprises: interacting by a computational resource manager with the computational resource repository and receiving an availability update of the computational resources available for processing the modules from the set while executing the scene graph application, and updating the set of computational resources available for processing the modules by the computational resource manager using the availability update.

In a further embodiment, the method comprises: receiving a computational resource information by the computational resource manager from the computational resource repository whenever any computational resource is added to or deleted from the computational resource repository, and updating the set of computational resources based on the computational resource information by the computational resource manager.

In a further embodiment, the method comprises: receiving the mapping from the module mapper by a memory manager and identifying if any of the modules in the set to be executed consecutively uses same computational resource from the set, and determining data transfer between the computational resources in the set by the memory manager while executing modules of the scene based application consecutively except when the modules being executed consecutively uses the same computational resource.

### BRIEF DESCRIPTION OF THE DRAWINGS

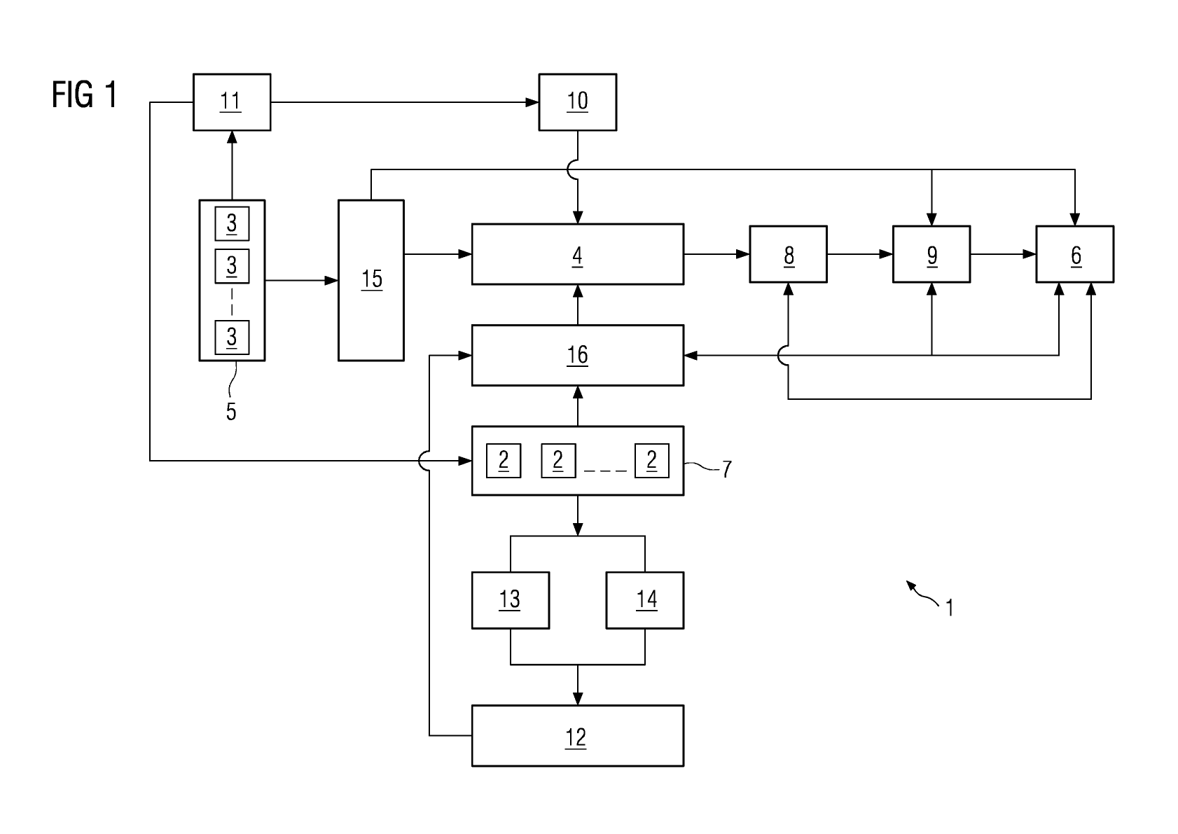

An exemplary embodiment will be explained in more detail below with reference to FIG. 1, which shows a schematic diagram of a computational resource allocation system.

### DETAILED DESCRIPTION

Embodiments of the present disclosure are configured to allocate computational resource for executing a scene graph based application efficiently and timely manner while the application is being executed.

According to an embodiment of the computational resource allocation system for the scene graph based application while the application is being executed, the system includes the module mapper which receives the set of modules to be used in the scene graph based application from the module repository and the set of computational resources available to process the modules from the computational resource repository, and maps the set of modules onto the set of computational resources to generate the mapping based on a performance matrix history defined by performance of each module on various computational resources. The allocation manager allocates the modules onto the set of computational resources based on the mapping. This performance matrix history aids the mapping of computation tasks to computation resources, thereby providing valuable inputs when trying to minimize overall execution time.

According to one embodiment of the system, the system includes a performance estimator which generates the performance matrix history of each of the module in the repository by executing each of the modules individually on the computational resources in the computational resource repository. The performance matrix history is generated before executing the scene graph based application. Providing the performance estimator with the system makes the system independent which need not rely on transfer of a performance matrix history from external sources, rather it generates the matrix history by itself.

According to another embodiment of the system, the system includes a computational resource manager which interacts with the computational resource repository, receives an availability update of the computational resources available for processing the modules from the set while executing the scene graph application and updates the set of computational resources available for processing the modules using the availability update. This reduces random mapping of the computational resources which are not available and may had cause delay in execution of the application, if they had been mapped.

According to yet another embodiment of the system, wherein the computational resource manager receives a computational resource information from the computational resource repository whenever any computational resource is added to or deleted from the computational resource repository and update the set of computational resource based on the computational resource information. This keeps an estimate of any newly added or deleted computational resource from the repository and updates the set of computational resources. Such estimation improves the execution performance of the application as a module can be mapped to a newly added computational resource for which module has better performance history and also reduces delays of any deleted computational resources by removing it from the set of computational resources to be mapped.

According to one embodiment of the system, the system includes a memory manager which receives the mapping from the module mapper, identifies if any of the modules in the set to be executed consecutively uses same computational resource from the set and determines data transfer between the computational resources in the set while executing modules of the scene based application consecutively except when the modules being executed consecutively uses the same computational resource. Such determination of data transfer is significant for timely and error free execution of the application.

The embodiments herein and the various features and advantageous details thereof are explained more fully with reference to the non-limiting embodiments that are illustrated in FIG. 1 and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to explaining functioning of the system through various embodiments, some of the terminology used herein will be explained.

“Module mapper”, “Hardware Manager”, “Performance Estimator”, “Allocation manager” and “Computational Resource Manager” are generally processors which are logic circuitry that responds to and processes the basic instructions for performing a function. They may be a central processing unit of a personal computer configured to perform the function or microprocessors which are multipurpose, programmable devices that accepts digital data as input, processes it according to instructions stored in its memory, and provides results as output or any other computing device configured to perform functions of the disclosed module mapper and/or hardware manager and/or allocation manager and/or performance estimator and/or computational resource manager according to current invention. However, technical difference between the module mapper, the performance estimator, the allocation manager, the hardware manager and the computational resource manager are explained through there functionalities while explaining the figures.

“Computational resources” are quantification of computation effort required to process modules in the set or solve a computation problem. A computational problem is generally defined in terms of its action on any valid input. Examples of problems might be “given an integer n, determine whether n is prime”, or “given two numbers x and y, calculate the product x*y”. As the inputs get bigger, the amount of computational resources needed to solve a problem will increase. Thus, the resources needed to solve a problem are described in terms of asymptotic analysis, by identifying the resources as a function of the length or size of the input. The simplest computational resources are computation time, the number of steps necessary to solve a problem, and memory space, the amount of storage needed while solving the problem, etc.

“Mapping” is a plan mentioning about allocation of computational resources to various modules in the set.

“Modules” are independent and interchangeable software components which altogether or in a selection can be linked together to be executed as an application, herein, a scene graph based application.

“Module repository” and “Computational resource repository” are databases stored in a memory device or in two different memory devices. The memory devices can be hard disk of a personal computer or a USB device or a compact disk or a floppy disk which can be physically connected to a processor through a data transfer interface. The memory device can also be connected to the processor through a computer network allowing data transfer from the memory device over the computer network to the processor through the data interface.

“Performance matrix history” is a mapping of execution of various modules from the module repository onto various computational resources from the computational resource repository. The mapping of execution is indicated through a value or a indicator representative of performance of the execution of a module over a computational resource.

“Availability update”

“Computational resource information” is defined as a data or an indicator representative of addition or deletion of a computational resource, which includes an identification of the computational resource. The availability update may include a mapping of execution of various modules onto the computational resource to adjust the performance matrix history as per the deletion or addition of the computational resource.

FIG. 1 shows a schematic diagram of a computational resource allocation system 1 including a module mapper 4, a performance estimator 11, a computational resource manager 12 and a memory manager 6 functions together to determine allocation the computational resources 2 to the modules 3 of a screen graph based application. The system 1 further includes an allocation manager for allocating the computational resources 2 to the modules 3 of the screen graph based application on above-said determination.

The module mapper 4 receives a set 16 of modules 3 to be used in the scene graph based application from a module repository 5 and a set 15 of computational resources 2 available to process the modules 3 from a computational resource repository 7, and maps the set 16 of modules 3 onto the set 15 of computational resources 2 to generate a mapping 8. Based on the mapping 8, an allocation manager 9 allocates the modules 3 to the set 15 of computational resources 2.

The module mapper 4 maps the set 15 of modules 3 onto the set 16 of computational resources 2 based on the performance matrix history 10 defined by performance of each module 3 on various computational resources 2. In an alternate embodiment, the mapper 4 need not map the set 15 of modules 3 onto the set 16 of computational resources 2 based on the performance matrix history 10; rather the mapper 4 randomly maps the set 15 of modules 3 onto the set 16 of computational resources 2. Yet alternatively, the mapper 4 may map based on a property of the computational resources 2 or based on property of module 3. The performance estimator 11 generates the performance matrix history 10 of each of the module 3 in the repository 5 by executing each of the modules 3 individually on the computational resources 2 in the computational resource repository 7. The performance matrix history 10 is generated before executing the scene graph based application. In an alternate embodiment, the performance estimator 11 is not included in the system 1; rather the performance matrix history 10 is procured by the mapper 4 from an external source.

The computational resource manager 12 interacts with the computational resource repository 7 and receives an availability update 13 of the computational resources 2 available for processing the modules 3 from the set 15 while executing the scene graph application and to update the set 16 of computational resources 2 available for processing the modules 3 using the availability update 13. In an alternate embodiment, the system need not include the computational resource manager 12, as the set 16 of computational resources 2 once fed into the mapper 4 need not change till the execution of the screen graph based application is performed.

The computational resource manager 12 also receives computational resource information 14 from the computational resource repository 7 whenever any computational resource 2 is added to or deleted from the computational resource repository 7 and updates the set 16 of computational resources 2 based on the computational resource information 14. In an alternate embodiment, the computational resource manager 12, as the set 16 of computational resources 2 once fed into the mapper 4 need not change till the execution of the screen graph based application is performed.

The system also includes a memory manager 6 configured to receive the mapping 8 from the module mapper 4 and identifies if any of the modules 3 in the set 15 to be executed consecutively uses same computational resource 2 from the set 16. The memory manager 6 further determines data transfer between the computational resources 2 in the set 16 while executing modules 3 of the scene based application consecutively except when the modules 3 being executed consecutively uses the same computational resource 2. In an alternate embodiment, the system 1 need not include memory manager 6 and data transfer between the computational resources 2 in the set 16 while executing modules 3 of the scene based application consecutively need not be monitored.

What is claimed is:

1. A computational resource allocation system for allocating computational resources to various modules of a scene graph based application while the application is being executed, the system comprising:
a module mapper configured to:
receive a set of modules to be used in the scene graph based application from a module repository and a set of computational resources available to process the modules from a computational resource repository, and
map the set of modules onto the set of computational resources to generate a mapping, and
an allocation manager configured to allocate the set of modules to the set of computational resources based on the mapping.

2. The system of claim 2, wherein the module mapper is configured to map the set of modules onto the set of computational resources based on a performance matrix history defined by performance of each module on various computational resources.

3. The system of claim 3, comprising:
a performance estimator configured to generate the performance matrix history of each module in the repository by executing each module individually on the computational resources in the computational resource repository,
wherein the performance matrix history is generated before executing the scene graph based application.

4. The system of claim 1, comprising:
a computational resource manager configured to:
interact with the computational resource repository,
receive an availability update of the computational resources available for processing the modules from the set while executing the scene graph application, and
update the set of computational resources available for processing the modules using the availability update.

5. The system of claim 4, wherein the computational resource manager is configured to:
receive a computational resource information from the computational resource repository in response to a computational resource being added to or deleted from the computational resource repository, and
update the set of computational resources based on the computational resource information.

6. The system of claim 1, comprising:
a memory manager configured to:
receive the mapping from the module mapper, to identify if any of the modules in the set to be executed consecutively uses same computational resource from the set, and
determine data transfer between the computational resources in the set while executing modules of the scene based application consecutively except when the modules being executed consecutively use the same computational resource.

7. A method for allocating computational resources to various modules of a scene graph based application while the application is being executed, the method comprising:
receiving a set of modules to be used in the scene graph based application from a module repository and a set of computational resources available to process the modules from a computational resource repository by a module mapper, and
mapping the set of modules onto the set of computational resources to generate a mapping,
using an allocation manager to allocate the set of modules to the set of computational resources based on the mapping.

8. The method of claim 7, comprising the module mapper mapping the set of modules onto the set of computational resources by based on a performance matrix history defined by performance of each module on various computational resources.

9. The method of claim 8, comprising:
generating the performance matrix history of each module in the repository by a performance estimator by executing each module individually on the computational resources in the computational resource repository,
wherein the performance matrix history is generated before executing the scene graph based application.

10. The method of claim 7, comprising:
interacting by a computational resource manager with the computational resource repository and receiving an availability update of the computational resources available for processing the modules from the set while executing the scene graph application, and
updating the set of computational resources available for processing the modules by the computational resource manager using the availability update.

11. The method of claim 10, comprising:
receiving computational resource information by the computational resource manager from the computational resource repository in response to a computational resource being added to or deleted from the computational resource repository and
updating the set of computational resources based on the computational resource information by the computational resource manager.

12. The method of claim 7, comprising:
receiving the mapping from the module mapper by a memory manager and identifying if any of the modules in the set to be executed consecutively uses same computational resource from the set, and
determining data transfer between the computational resources in the set by the memory manager while executing modules of the scene based application consecutively except when the modules being executed consecutively use the same computational resource.
